(19) United States
(12) Patent Application Publication
(10) Pub. No.: US 2005/0089189 A1
(43) Pub. Date: Apr. 28, 2005

(54) Embedding a watermark in an image signal

(76) Inventor: Gerrit Cornelis Langelaar, Eindhoven (NL)

Correspondence Address: Philips Electronics North America Corporation;Corporate Patent Counsel, PO Box 3001, Briarcliff Manor, NY, 10510, US

(21) Appl. No.: 10/497,334

(22) PCT Filed: Nov. 13, 2002
(86) PCT No.: PCT/IB02/04794

(30) Foreign Application Priority Data
Dec. 5, 2001 (EP) 01204680.1

(51) Int. Cl. G06K 9/00

(52) U.S. Cl. 382/100

(57) ABSTRACT

A method and arrangement are disclosed for embedding a watermark (W) in a media signal (MP) comprising signal samples (x(n)) being encoded as variable-length code words (VLC). The variable-length coded DCT coefficients of an MPEG2 video signal constitute such a media signal. The watermark is embedded by inverting the signs of the AC coefficients as far as such an inversion indeed causes the coefficients to be increased or decreased as prescribed (s(n)) by the watermark to be embedded. The invention is simple to implement, does not require re-encoding of the signal and does not affect the bit rate of the bit stream.

### FIELD OF THE INVENTION

The invention relates to a method and arrangement for embedding a watermark in a media signal comprising signal samples being encoded as variable-length code words, comprising the steps of decoding variable-length code words into said signal samples, modifying selected signal samples in accordance with respective samples of the watermark to be embedded, and re-encoding the modified signal samples.

### BACKGROUND OF THE INVENTION

A known method of embedding a watermark in a media signal as defined in the opening paragraph is disclosed in F. Hartung and B. Girod: “Digital Watermarking of MPEG-2 Coded Video in the Bitstream Domain”, published in ICASSP, Vol. 4, 1997, pp. 2621-2624. In this prior-art publication, the media signal is an MPEG-compressed video signal. The signal samples of the media signal are DCT coefficients obtained by subjecting the image pixels to a Discrete Cosine Transform. The watermark is a DCT-transformed pseudo-noise sequence. The watermark is embedded by adding the samples of this transformed noise sequence to the corresponding DCT coefficients. The zero coefficients of the MPEG-coded signal are not affected.

A problem of this prior-art watermark embedding scheme is that modification of DCT coefficients generally changes the bit rate of the bit stream, because the DCT coefficients are represented by variable-length code words. A higher bit rate is usually not acceptable. The prior-art embedder therefore checks whether transmission of the modified coefficient increases the bit rate, and transmits the original-coefficient in that case. The reduction of the bit rate is not desired. In MPEG systems, for example, a change of the bit rate may result in overflow or underflow of buffers in the decoder and change the position of timing information in the bit stream.

### OBJECT AND SUMMARY OF THE INVENTION

It is an object of the invention to provide a method of embedding a watermark which alleviates the above-mentioned drawbacks.

To this end, the method according to the invention is characterized in that the modifying step is applied to signal samples represented by variable-length code words having the same length for signal samples having the same magnitude but a different sign, and comprises the step of inverting the sign of said signal samples if said inversion causes the signal samples to be increased or decreased as prescribed by the respective samples of the watermark.

By modifying only the signs of signal samples, and leaving the magnitudes unaffected, the lengths of the variable-length code words are not changed by the watermark embedding process. It is thus achieved with the invention that the bit rate remains unaffected.

The amount by which a signal sample is modified by inverting its sign equals twice its magnitude. Such a modification may be too large. In an embodiment of the method, the step of inverting is therefore dependent upon the magnitude of the signal sample.

The invention is particularly advantageous in compression schemes, such as MPEG, that use variable-length codes having a sign bit representing the sign of the signal sample and a variable-length coded magnitude of the signal sample. The separate step of re-encoding can then be dispensed with. It is sufficient to invert the sign bit of the variable-length code word.

### BRIEF DESCRIPTION OF THE DRAWINGS

FIG. 1 shows a schematic diagram of an arrangement for embedding a watermark in a media signal according to the invention.

FIGS. 2A-2D show waveforms to illustrate the operation of the arrangement which is shown in FIG. 1.

FIG. 3 shows a flow chart of operations carried out by the arrangement which is shown in FIG. 1.

FIGS. 4A-4C show waveforms to illustrate an alternative operation of the arrangement which is shown in FIG. 1.

FIG. 5 shows a schematic diagram of a further embodiment of an arrangement for embedding a watermark in a media signal according to the invention.

FIGS. 6A-6C and 7A-7G show diagrams to illustrate the operation of the arrangement which is shown in FIG. 5.

FIG. 8 shows a flow chart of operations carried out by the arrangement which is shown in FIG. 5.

FIG. 9 illustrates the watermark detection process.

### DESCRIPTION OF A PREFERRED EMBODIMENT

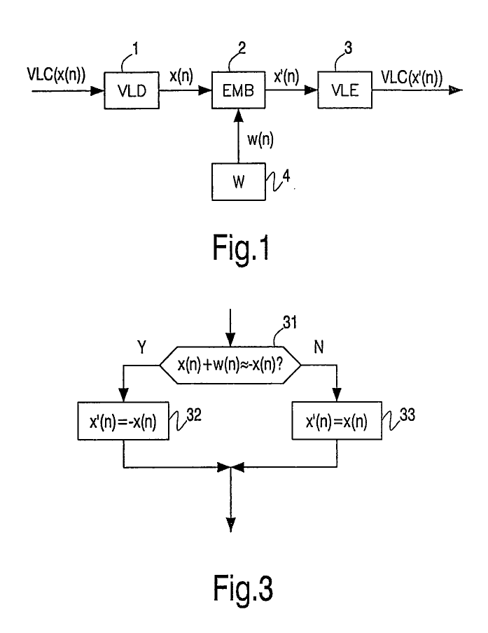

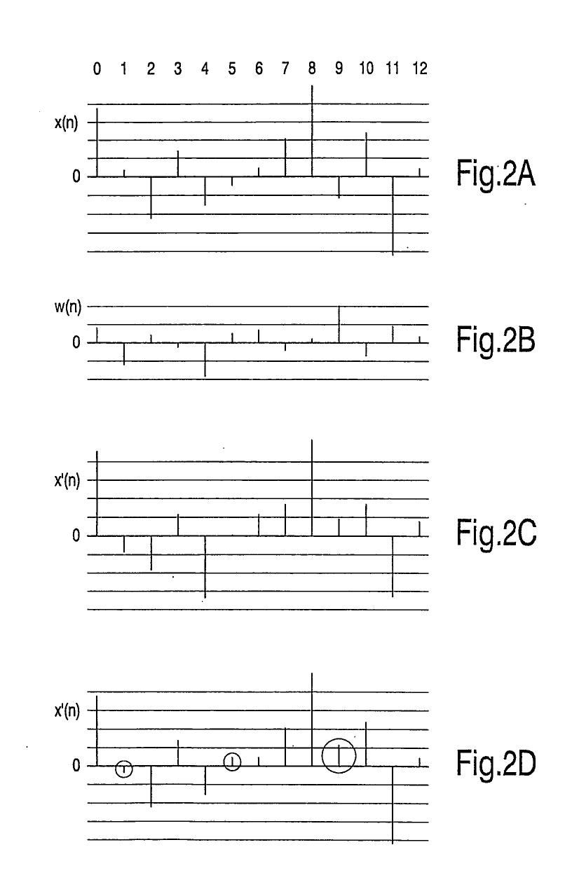

FIG. 1 shows a schematic diagram of an arrangement for embedding a watermark in a media signal according to the invention. The arrangement comprises a variable-length decoder 1, a watermark embedding stage 2, a variable-length encoder 3, and a watermark buffer 4. The arrangement receives the media signal in the form of variable-length code words VLC(x(n)), each representing a sample x(n) of the media signal. The samples may be DPCM samples, or Fourier or DCT coefficients, of an audio, video or data signal. An example of a series x(0) . . . x(12) of signal samples x(n) as decoded by the variable-length decoder 1 is shown in FIG. 2A (the indexes n are shown at the top of FIG. 2A).

The watermark W to be embedded is a series of watermark samples w(n). It is stored in the watermark buffer 4. FIG. 2B shows an example of a series of watermark samples w(0) . . . w(12). It will be assumed in this example that the arrangement performs additive watermark embedding. This means that the watermark samples w(n) are added to the corresponding series of signal samples x(n), as illustrated in FIG. 2C. In mathematical notation:
x′(n)=x(n)+w(n).

It should be noted that the watermark samples are much smaller than the signal samples in practice.

The watermarked signal samples x′(n) are subsequently re-encoded into variable-length code words VLC(x′(n)) by the variable-length encoder 3. A problem of such an unconditional additive watermark embedding process is that the output variable-length code words VLC(x′(n)) will generally have different lengths LEN than the corresponding input variable-length code words VLC(x(n)). The output bit rate thus generally differs from the input bit rate, which is not desirable. The Hartung and Girod article mentioned hereinbefore provides a solution to this problem by leaving a signal sample x(n) unaffected if its modification increases the length of the corresponding variable-length code word.

According to this invention, the modification of signal samples is restricted to those signal samples that are represented by variable-length code words having the same length for signal samples having the same magnitude but a different sign. For convenience, it will be assumed that this condition is fulfilled for all variable-length codes in this example, i.e. that:
LEN{VLC(x(n))}=LEN{VLC(−x(n))} for all x(n)

Watermark embedding is now performed by inverting the sign of the signal sample x(n) if said inversion indeed causes the signal sample to be increased or decreased as prescribed by the respective sample of the watermark. This operation is performed by the embedding stage 2. FIG. 3 shows a flow chart of operations carried out by an embodiment of this embedding stage. In a step 31, it is checked whether the result of adding the watermark sample w(n) to signal sample x(n) has substantially the same effect as inverting the signal sample's sign. “Substantially” maybe defined to mean that the difference between x(n)+w(n) and −x(n) is less than a given threshold, or that x(n)+w(n) has at least the same sign as −x(n). If that is the case, a step 32 is performed in which the sign of x(n) is indeed inverted. Otherwise, the sample x(n) remains unaffected in a step 33.

FIG. 2D shows the signal samples x′(n) of the watermarked media signal thus obtained. The inverted signal samples have been encircled in this Figure. Their values correspond substantially to the “prescribed” values that are shown in FIG. 2C. The other signal samples have not been modified, because the condition 31 is not fulfilled.

It is achieved with the above described watermark embedding by sign inversion (also referred to as “sign bit flipping”) that each variable-length code word VLC(x′(n)) in the output bit stream has the same length as the corresponding variable-length code word VLC(x(n)) in the input bit stream. Not only does the average bit rate remain unchanged, but also the bit rate does not even change momentarily. Each and every code word of the bit stream maintains its original position, and there is no risk that timing-critical positions of other information in the bit stream, such as time stamps, are altered.

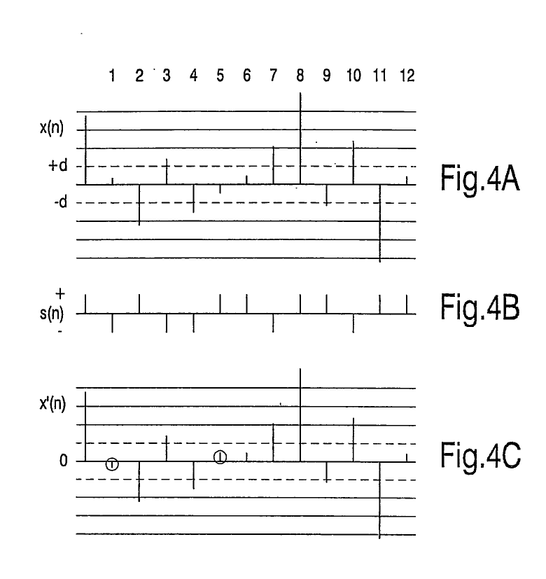

FIGS. 4A-4C show diagrams to illustrate the operation of an alternative embodiment of the arrangement which is shown in FIG. 1. In this embodiment, the watermark buffer 4 merely stores the signs s(n) of the respective watermark samples w(n). This embodiment is advantageous in that it requires only one bit per watermark sample to be stored in the buffer 4. As illustrated in FIG. 4B, the signs s(n) merely indicate whether the corresponding signal samples are to be increased (+) or decreased (−). In this embodiment, the embedding stage 2 inverts the sign of a signal sample x(n) if said inversion causes the signal sample to be increased or decreased as prescribed by the watermark sample. Because the amount by which a signal sample is to be modified is no longer prescribed and may be too large (viz. twice its magnitude), the inversion is preferably carried out for small magnitudes only (e.g. smaller than a threshold d). FIG. 4C shows the watermarked signal x′(n) of such an embodiment. Similarly as in FIG. 2D, the inverted signal samples are denoted by encircling. There is only a slight decrease of performance compared with FIG. 2D. Signal sample x(9), which was inverted in FIG. 2D because the corresponding watermark sample w(9) was exceptionally large, has not been inverted in FIG. 4C, because its magnitude is above the threshold d.

A practical embodiment of the arrangement will now be described with reference to embedding of a watermark in a video signal being compressed in accordance with the MPEG2 standard. Note that the media signal may already have an embedded watermark. In that case, an additional watermark is embedded. This process of watermarking an already watermarked signal is usually referred to as “remarking”.

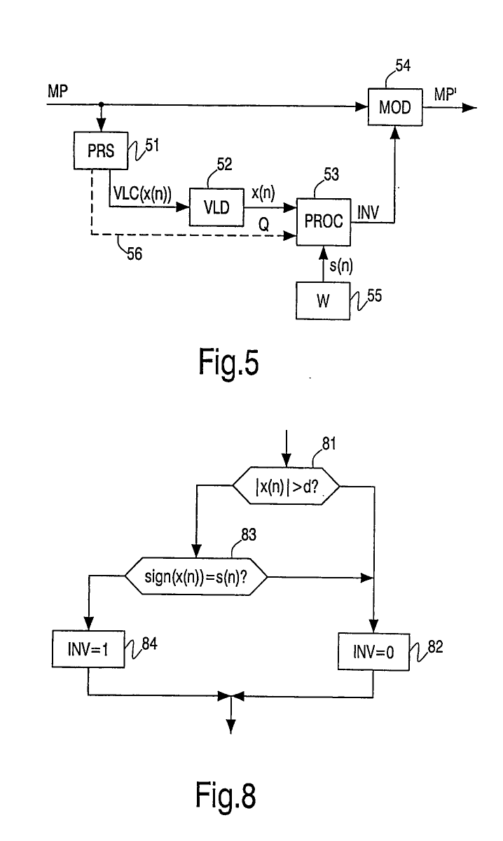

FIG. 5 shows a schematic diagram of an arrangement carrying out a preferred embodiment of the method according to the invention. The arrangement comprises an MPEG parsing unit 51, a variable-length decoder 52, a processing unit 53, an output unit 54, and a watermark buffer 55.

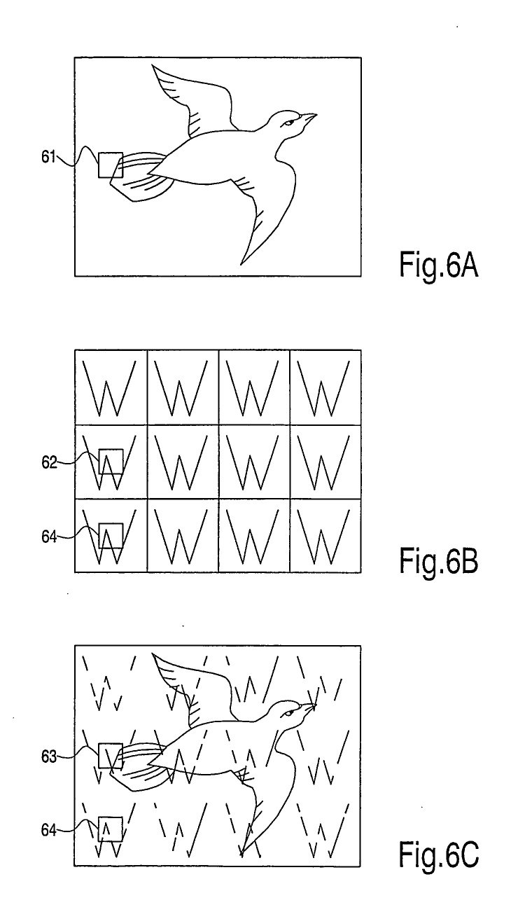

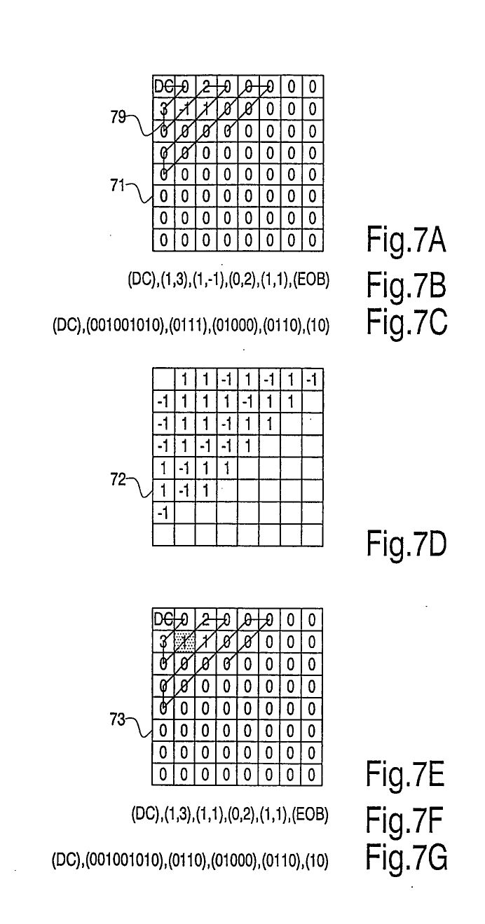

The arrangement receives an MPEG video stream MP which represents a sequence of video images. One such video image is shown in FIG. 6A by way of illustrative example. The video images have been divided into blocks of 8×8 pixels, one of which is denoted 61 in FIG. 6A. The pixel blocks are represented by respective blocks of 8×8 DCT coefficients. The upper left transform coefficient of such a DCT block represents the average luminance of the corresponding pixel block and is commonly referred to as the DC coefficient. The other coefficients represent spatial frequencies and are referred to as AC coefficients. The upper left AC coefficients represent coarse details of the image, the lower right coefficients represent fine details. The AC coefficients are quantized. This quantization process causes many AC coefficients of a DCT block to assume the value zero. FIG. 7A shows a typical example of a DCT block 71 representing image block 61 in FIG. 6A.

The coefficients of the DCT block have been sequentially scanned in accordance with a zigzag scan pattern (79 in FIG. 7A) and variable-length encoded. The variable-length encoding scheme adopted by MPEG is a combination of Huffinan coding and run-length coding. More particularly, each run of zero AC coefficients and a subsequent non-zero AC coefficient constitutes a (run,level) pair. In each (run,level) pair, “run” denotes the number of zero coefficients, and “level” is the value of the non-zero coefficient. An End-Of-Block code (EOB) denotes the absence of further non-zero coefficients in the DCT block. FIG. 7B shows the series of (run,level) pairs representing DCT block 71.

The (run,level) pairs are represented by variable-length code words. A property of the variable-length coding scheme adopted by MPEG is that coefficients having the same magnitude but a different sign are represented by equal-length code words. For example, the (run,level) pairs (1,−1) and (1,1) are encoded as equal-length code words 0111 and 0110, respectively. FIG. 7C shows the variable-length code words representing DCT block 71 as received by the arrangement which is shown in FIG. 5.

In an MPEG2 video stream, four DCT luminance blocks and two DCT chrominance blocks constitute a macroblock, a number of macroblocks constitutes a slice, a number of slices constitutes a picture (field or frame), and a series of pictures constitutes a video sequence. Some pictures are autonomously encoded (I-pictures), other pictures are predictively encoded with motion compensation (P and B-pictures). In the latter case, the DCT coefficients represent differences between pixels of the current picture and pixels of a reference picture rather than the pixels themselves.

The MPEG2 video stream MP is applied to the parsing unit 51 (FIG. 5). This parsing unit partially interprets the KPEG bit stream and applies the variable-length code words (VLCs) representing luminance DCT coefficients to the variable-length decoder 52. The parsing unit 51 also gathers information such as: the coordinates of the blocks, the coding type (field or frame), the scan type (zigzag or alternate). The variable-length decoder 52 decodes the variable-length code words representing the video image into (run,level) pairs, and converts the (run,level) pairs into a series of DCT coefficients x(0) . . . x(63) in the order of the zigzag scan.

The watermark to be embedded is a pseudo-random noise sequence in the pixel domain. In this embodiment of the arrangement, a 128×128 watermark pattern is to be “tiled” over the extent of the image. This tiling operation is illustrated in FIG. 6B. The 128×128 pseudo-random waternark pattern is herein shown as a symbol W for better visualization. The spatial noise values of the watermark W are transformed to the same representation as the video content in the MPEG stream. To this end, the 128×128 watermark pattern is likewise divided into 8×8 blocks, one of which is denoted 62 in FIG. 6B. The blocks are discrete cosine transformed. The signs s(n) of the coefficients thus calculated are stored in the 128×128 watermark buffer 55 of the arrangement. The signs indicate whether the corresponding DCT coefficients of the video signal are to be increased or decreased. Only the most significant AC coefficients of an image block are candidates for modification so as to avoid that the embedded watermark destroys fine image details. Accordingly, only the signs s(1) . . . s(32) in the zigzag sequence are stored in the buffer. FIG. 7D shows an example of a block 72 in the watermark buffer 55 thus obtained. Note that these operations need to be done only once and can be done off-line.

The AC coefficients x(n) and the watermark samples s(n) are applied to the processing unit 53. This processing unit determines which of the coefficients x(n) will be inverted so as to embed the watermark. More particularly, the sign of a coefficient x(n) is to be inverted if that causes the coefficient to be increased or decreased as prescribed by the corresponding watermark sample s(n). To avoid that coefficients are modified by a too large amount (for example, that the coefficient x(2)=3 in FIG. 7A will be turned into x′(2)=−3), the embedding operation is carried out for small magnitudes only. For MPEG-encoded video, the following rule appears to be feasible in practice:
if (x(n)=−1 && s(n)=+1) then x(n)=−x(n)
if (x(n)=+1 && s(n)=−1) then x(n)=−x(n)

The arrangement which is shown in FIG. 5 also exploits the property of the MPEG variable-length encoding scheme that each variable-length code word comprises one bit representing the sign of the non-zero coefficient and a variable number of bits representing its magnitude. It suffices to invert the sign of the respective variable-length code word. This is performed by the output unit 54 in response to a signal INV of the processing unit 53. The actual re-encoding of modified coefficients can thus be dispensed with.

FIG. 8 shows a flow chart of the operations being carried out by the processing unit 53. In a step 81, it is checked whether the magnitude of coefficient x(n) is larger than 1. If that is the case, the output unit is signaled not to invert the sign bit of the corresponding variable-length code word (step 82). Neither is the sign bit inverted if it is concluded, in a step 83, that the required operation (increasing or decreasing of the coefficient) cannot be achieved by inverting its sign. Only if the relevant conditions are fulfilled is the signal INV=1 is applied to the output unit 53 so as to instruct this unit to invert the sign bit of the respective variable-length code word in the MPEG video bit stream.

FIG. 7E shows the result of embedding the watermark in DCT block 71. Only one coefficient (x(4), shaded in this Figure) has been modified in this example, because this coefficient is negative, has a small magnitude, and is to be increased. Zero coefficients are not affected. Coefficients x(2)=3 and x(5)=2 are not modified because of their too large magnitude. Coefficients x(5)=2 and x(7)=1 are not modified because the prescribed modification (increase) cannot be achieved by inverting the sign bit. FIG. 7F shows the new (run,level) pairs. FIG. 7G shows the corresponding series of variable-length code words.

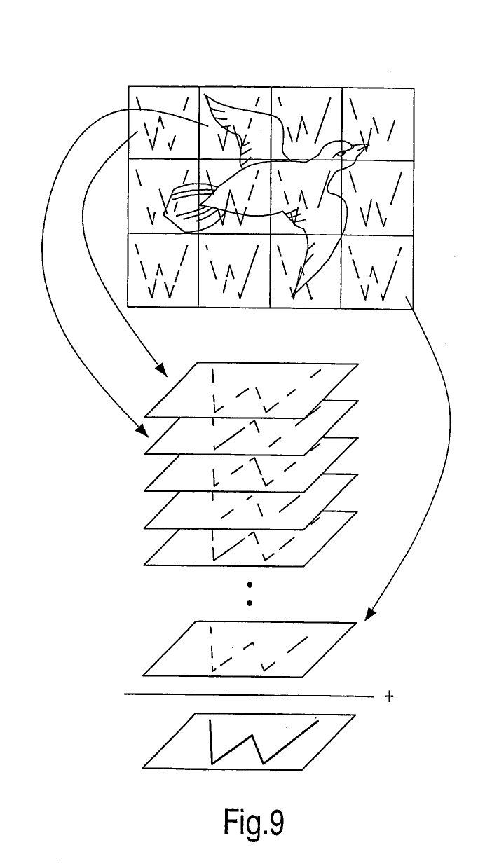

FIG. 6C shows the watermarked image. As has been attempted to express in this Figure, the amount of watermark embedding varies from block to block. Whereas only one DCT coefficient has been modified in DCT block 63, more and other coefficients will generally have been modified in other DCT blocks. More particularly, watermarked image block 63 has been embedded with a different embedding “strength” or “depth” than image block 65 corresponding to the same watermark block 64 at a different location of the image. The amount of watermarking also varies from tile to tile. This is compensated for during detection of the watermark, where the tiles are added (“folded”) in a 128×128 video buffer as illustrated in FIG. 9. The watermark has a strong presence in this buffer and can easily be detected, for example, by correlation techniques such as disclosed in International Patent Application WO 99/45705.

In the above described arrangement for embedding a watermark in an MPEG encoded signal, the “level” part of (run,level) pairs is changed. However, a level is not an actual value of an AC coefficient, but a quantized version thereof. For example, the level x(4)=−1 in FIG. 7A may in fact represent a coefficient X(4)=−104. After the bit flip operation, the new value is X′(4)=+104. In another block, the same x(4)=−1 may represent a coefficient X(4)=−6, depending on the quantizer step size. Needless to say that the effect of turning an AC coefficient from −104 into +104 will generally have a different effect on the perceptibility of the embedded watermark than turning the same AC coefficient from 31 6 into +6.

There may thus be a need to control the watermark embedding process in such a way that the effect thereof on visibility is reduced. To this end, a further embodiment of the embedding method includes the step of controlling the number and/or positions of coefficients being modified in dependence upon the quantizer step size.

In an MPEG decoder, inverse quantization is achieved by multiplying the received level x(n) with the quantizer step size. The quantizer step size is controlled by a weighting factor W(n) which modifies the step size within a block and a scale factor QS which modifies the step size from (macro)block to (macro)block. The following equation specifies MPEG's arithmetic to reconstruct an AC coefficient X(n) from the decoded level x(n):
X(n)=x(n)×W(n)×QS

There are various ways of generating an upper boundary for the number of coefficients that are allowed to be modified. In one embodiment, a level x(n) may only be modified if the corresponding quantizing step size Q(n)=W(n)×QS is less than a predetermined threshold. Different thresholds may thereby be used for different block positions (i.e. for different indexes n).

In another embodiment, the maximum number N of coefficients that are allowed to be modified in a block is a function of the quantizer scale factor QS such that N decreases as QS increases. The feasibility of this embodiment can easily be understood if one realizes that the scale factor in fact indicates how strongly a DCT block has been quantized. The larger the scale factor, i.e. the larger the quantization step size, the fewer coefficients may be changed in order to render the effect imperceptible. An example of such a function is:

$$N = \frac{c}{QS}$$

where c is a given constant value.

The quantizer scale factor QS is accommodated in MPEG bit streams as a combination of a parameter quantizer_scale_code and a parameter q_scale_type. The parameter quantizer_scale_code is a 5-bit code. The parameter q_scale_type indicates whether said code represents a linear range of QS-values between 2 and 62, or an exponential range of values between 1 and 112. In both cases, the code is indicative of the step size. Accordingly, the term QS in the above-mentioned function may also be replaced by the parameter quantizer_scale_code.

It is also advantageous to control the positions of the coefficients being modified by the watermark process in dependence upon the quantizer step size. The larger the quantizer step size, the later in the zigzag scan the desired modifications are carried out. This leaves the low-frequency coefficients unaffected and restricts the visibility of the watermark embedding process to the higher frequency coefficients.

The feature of controlling the maximum number and/or the positions of modifiable coefficients in dependence upon the quantizer step size requires only a minor modification of the arrangement. To this end, the parsing unit 51 in FIG. 5 is arranged to read the relevant parameters quantizer_scale_code and q_scale_type and/or the weighting matrix W(n) (collectively denoted Q in FIG. 5) from the bit stream MP and apply them to the processing unit 53 via the dashed line 55. The flow chart illustrating the operation of said processing unit, which is shown in FIG. 8, now includes a step (not shown) so as to test whether the maximum number N of coefficients has already been modified.

It should be noted that the concept of limiting the number and/or positions of modified signal samples within a given series of signal samples in dependence upon the quantizer step size is not restricted to the bit-flip watermarking algorithm. It may also be used in other watermarking algorithms, such as the one proposed in Applicant's patent application EP 01200277.0 in which signal samples are zeroed in order to embed the watermark. The concept of limiting the number of modified signal samples may even be applied in other signal processing algorithms than watermarking.

The invention can be summarized as follows. A method and arrangement are disclosed for embedding a watermark (W) in a media signal (MP) comprising signal samples (x(n)) being encoded as variable-length code words (VLC). The variable-length coded DCT coefficients of an MPEG2 video signal constitute such a media signal. The watermark is embedded by inverting the signs of the AC coefficients as far as such an inversion indeed causes the coefficients to be increased or decreased as prescribed (s(n)) by the watermark to be embedded. The invention is simple to implement, does not require re-encoding of the signal and does not affect the bit rate of the bit stream.

1. A method of embedding a watermark in a media signal comprising signal samples being encoded as variable-length code words, the method comprising the steps of:
decoding variable-length code words into said signal samples;
modifying selected signal samples in accordance with respective samples of the watermark to be embedded;
re-encoding the modified signal samples;
characterized in that said modifying step is applied to signal samples represented by variable-length code words having the same length for signal samples having the same magnitude but a different sign, and comprises the step of inverting the sign of said signal samples if said inversion causes the signal samples to be increased or decreased as prescribed by the respective samples of the watermark.

2. A method as claimed in claim 1, wherein said step of inverting is depedent upon the magnitude of the signal sample.

3. A method as claimed in claim 1, in which the variable-length code words comprise a sign bit representing the sign of the signal sample and a variable-length coded magnitude of the signal sample, characterized in that the steps of inverting and re-encoding a signal sample are performed by inverting the sign bit of the respective variable-length code word.

4. A method as claimed in claim 1, wherein said media signal is a transform-coded signal, the signal samples being formed by transform coefficients.

5. A method as claimed in claim 1, wherein the media signal comprises series of signal samples being quantized with a quantizer step size, the method including the step of controlling the number and/or positions of signal samples that may be modified within each series, in dependence upon said quantizer step size.

6. An arrangement for embedding a watermark (w(n)) in a media signal comprising signal samples (x(n)) being encoded as variable-length code words (VLC(x(n))), the arrangement comprising:
means (1; 52) for decoding variable-length code words into said signal samples;
means (2; 54) for modifying selected signal samples in accordance with respective samples of the watermark to be embedded;
means (3; 54) for re-encoding the modified signal samples;
characterized in that said modifying means is arranged to apply said modifying step to signal samples represented by variable-length code words having the same length for signal samples having the same magnitude but a different sign, and comprises means (2) for inverting the sign of said signal samples if said inversion causes the signal samples to be increased or decreased as prescribed by the respective samples of the watermark.

7. An arrangement as claimed in claim 6, in which the variable-length code words comprise a sign bit representing the sign of the signal sample and a variable-length coded magnitude of the signal sample, characterized in that the means for inverting and re-encoding a signal sample are performed by means (54) for inverting the sign bit of the respective variable-length code word.

8. An arrangement as claimed in claim 6, wherein the media signal comprises series of signal samples being quantized with a quantizer step size, the arrangement including means (53)for controlling the number and/or positions of signal samples that may be modified within each series, in dependence upon said quantizer step size (Q).
